(19) United States
(12) Patent Application Publication
(10) Pub. No.: US 2020/0139957 A1
(43) Pub. Date: May 7, 2020

(54) HYBRID VEHICLE

(71) Applicant: Toyota Jidosha Kabushiki Kaisha, Toyota-shi Aichi-ken (JP)

(72) Inventor: Koichiro Muta, Okazaki-shi Aichi-ken (JP)

(73) Assignee: Toyota Jidosha Kabushiki Kaisha, Toyota-shi Aichi-ken (JP)

(21) Appl. No.: 16/671,970

(22) Filed: Nov. 1, 2019

(30) Foreign Application Priority Data
Nov. 5, 2018 (JP) 2018-208041

(51) Int. Cl. B60W 20/15; F01N 3/021; B60L 50/60; B60L 15/20; F02D 41/02; B60K 6/46; B60K 17/24; B60K 17/04; B60K 1/02; B60W 10/06; B60W 10/08; B60W 10/115; B60W 30/188; B01D 46/00; B01D 46/46

(52) U.S. Cl. CPC B60W 20/15; B60L 58/13; B60L 50/66; B60L 15/2045; F02D 41/029; B60K 6/46; B60K 17/24; B60K 17/046; B60K 1/02; B60W 10/06; B60W 10/08; B60W 10/115; B60W 30/1884; B01D 46/0063; B01D 46/46; F02D 2200/101; B60Y 2200/92; F01N 3/021

(57) ABSTRACT

A hybrid vehicle includes an engine in which a filter for removing particulate matter is attached to an exhaust system, a motor that is connected to an output shaft of the engine, and a power storage device that exchanges an electric power with the motor, sets a target power of the engine based on a traveling power needed to travel, and controls the engine and the motor to output the target power from the engine and travel based on the traveling power. Further, the hybrid vehicle sets the target power by imposing a limit when a deposition amount of the particulate matter deposited on the filter is equal to or greater than a predetermined amount, as compared to when the deposition amount is less than the predetermined amount.

### CROSS-REFERENCE TO RELATED APPLICATIONS

This application claims priority to Japanese Patent Application No. 2018-208041 filed on Nov. 5, 2018, which is incorporated herein by reference in its entirety including the specification, drawings and abstract.

### BACKGROUND

### 1. Technical Field

The present disclosure relates to a hybrid vehicle, and more particularly, to a hybrid vehicle including an engine in which a filter for removing particulate matter is attached to an exhaust system.

### 2. Description of Related Art

In a hybrid vehicle of the related art including an engine in which a filter for removing particulate matter is attached to an exhaust system, a motor connected to an output shaft of the engine and a battery that exchanges an electric power with the motor, it has been suggested to perform regeneration of filter (see, for example, Japanese Unexamined Patent Application Publication No. 2015-202832 (JP 2015-202832 A)). In this type of hybrid vehicle, when filter regeneration is requested, a control range of the residual capacity of the battery is expanded more than when the filter regeneration is not requested, the residual capacity is made to be lower than a lower limit before the expansion of the control range and then increased greater than a upper limit before the expansion of the control range, and then fuel injection of the engine is stopped and the engine is motored by the motor. When the fuel injection of the engine is stopped, air containing oxygen is supplied to the filter and the particulate matter burns. In this way, the filter is regenerated.

### SUMMARY

In the hybrid vehicle described above, when fuel injection of the engine is stopped to perform filter regeneration, the temperature of the filter is likely to increase due to the burning of particulate matter deposited on the filter, which may result in damage of the filter.

A main object of a hybrid vehicle of the present disclosure is to suppress damage of a filter.

The hybrid vehicle of the present disclosure employs the following to achieve the main object described above.

An aspect of the present disclosure relates to a hybrid vehicle. The hybrid vehicle includes an engine, a motor, a power storage device, and a control device. The engine includes a filter for removing particulate matter is attached to an exhaust system. The motor is connected to an output shaft of the engine. The power storage device exchanges an electric power with the motor. The control device configured to set a target power of the engine based on a traveling power needed to travel, and control the engine and the motor to output the target power from the engine and travel based on the traveling power. The control device is configured to set the target power by imposing a limit when a deposition amount of the particulate matter deposited on the filter is equal to or greater than a predetermined amount, as compared to when the deposition amount is less than the predetermined amount.

With the hybrid vehicle according to the aspect, the target power of the engine is set based on the traveling power needed to travel, and the engine and motor are controlled to output the target power from the engine and travel based on the traveling power. Further, the hybrid vehicle sets the target power by imposing a limit when a deposition amount of the particulate matter deposited on the filter is equal to or greater than a predetermined amount, as compared to when the deposition amount is less than the predetermined amount. In this way, when the deposition amount is equal to or greater than the predetermined amount, it is possible to suppress an increase in the temperature of the filter when fuel injection of the engine is performed, and then to suppress overheating of the filter when fuel cut is performed. As a result, damage of the filter can be suppressed.

In the hybrid vehicle according to the aspect, the control device may set the target power by imposing a strict limit when the deposition amount is larger as compared to when the deposition amount is smaller, when the deposition amount is equal to or greater than the predetermined amount. Through experiments and analysis, the inventors have shown that an area where the filter is likely to be damaged expands toward the lower temperature of the filter as the deposition amount increases. Therefore, by setting the target power as described above, it is possible to suppress damage of the filter more appropriately.

In the hybrid vehicle according to the aspect, the control device may set an allowable upper limit power of the engine to be smaller when the deposition amount is equal to or greater than the predetermined amount as compared to when the deposition amount is less than the predetermined amount, and may set the target power within a range equal to or less than the allowable upper limit power based on the traveling power. With the hybrid vehicle according to the aspect, it is possible to set the target power by imposing the limit, such as reducing the allowable upper limit power, when the deposition amount is equal to or greater than the predetermined amount, as compared to when the deposition amount is less than the predetermined amount.

In the hybrid vehicle according to the aspect, in which the target power is set within the range equal to or less than the allowable upper limit power of the engine, the control device may set an allowable upper limit engine speed of the engine to be small when the allowable upper limit power is smaller as compared to when the allowable upper limit power is larger, and may control the engine such that the engine speed of the engine is equal to or less than the allowable upper limit engine number. Through experiments and analysis, the inventors have shown that the intake air amount needed to output the same power increases as the number of revolutions of the engine increases, and that the temperature of the filter increases as the intake air amount increases. Therefore, by setting the allowable upper limit engine speed of the engine and controlling the engine within the range equal to or less than the allowable upper limit engine speed as described above, it is possible to suppress the increase in the temperature of the filter when the target power is output from the engine.

The hybrid vehicle according to the aspect, in which the engine is controlled such that the engine speed of the engine is equal to or less than the allowable upper limit engine speed, may further include a planetary gear in which three rotational elements are connected to the engine, the motor, and a drive shaft coupled to an axle, such that the motor, the engine, and the drive shaft are arranged in this order in a collinear diagram, and a second motor that is connected to the drive shaft and exchanges an electric power with the power storage device, where the control device may set an allowable upper limit vehicle speed based on the allowable upper limit engine speed, a range of an allowable rotation speed of the motor, and ranges of an allowable rotation speed of the rotational elements of the planetary gear, and may control the engine, the motor and the second motor such that the vehicle speed is equal to or less than an allowable upper limit vehicle speed. With the hybrid vehicle according to the aspect, it is possible to suppress excessive rotation of the motor or rotational elements of the planetary gear.

The hybrid vehicle according to the aspect, in which the engine is controlled such that the number of revolutions of the engine is equal to or less than the allowable upper limit number of revolutions, may further a transmission of which an output shaft is connected to a drive shaft coupled to an axle, a planetary gear in which three rotational elements are connected to the engine, the motor, and an input shaft of the transmission such that the motor, the engine, and the input shaft are arranged in this order in ancollinear diagram, and a second motor that is connected to the drive shaft and exchanges an electric power with the power storage device, where the control device may set an allowable lower limit gear stage based on the allowable upper limit engine speed, a range of an allowable rotation speed of the motor, and a range of an allowable rotation speed of the planetary gear, and may control the transmission such that a gear stage is equal to or greater than the allowable lower limit gear stage. With the hybrid vehicle according to the aspect, it is possible to suppress excessive rotation of the motor or rotational elements of the planetary gear.

In the hybrid vehicle according to the aspect, when the control device sets the target power by imposing the limit, the control device may notify that output is insufficient when traveling by the traveling power is not possible and may not notify that output is insufficient when traveling by the traveling power is possible. With the hybrid vehicle according to the aspect, it is possible to notify a driver of insufficient output based on the target power set by imposing the limit. In addition, when the target power is set by imposing the limit, it is possible to suppress excessive frequency of notification of insufficient output as compared to when notification of insufficient output is issued regardless of whether traveling can be performed by the traveling power.

In the hybrid vehicle according to the aspect, in which the notification of insufficient output is issued as needed, when the control device sets the target power by imposing the limit, the control device may notify that output is insufficient when determination power based on the traveling power is larger than a threshold value and may not notify that output is insufficient when the determination power is equal to or less than the threshold value, and the threshold value may be set to be a smaller value when a forced charging of the power storage device is requested as compared to when the forced charging of the power storage device is not requested. With the hybrid vehicle according to the aspect, by considering whether or not the forced charging of the power storage device is requested, it is possible to more appropriately determine whether to notify that output is not sufficient. In this case, the threshold value may be set to be a sum of the allowable upper limit power of the engine and an allowable output electric power of the power storage device when the forced charging of the power storage device is not required, and may be set to be the allowable upper limit power of the engine when the forced charging of the power storage device is requested.

In the hybrid vehicle according to the aspect, in which the notification of insufficient output is issued as needed, the control device may set the determination power by correcting the traveling power in consideration of at least one of air density of air taken into the engine, and difference between a charge/discharge request power of the power storage device and an actual charge/discharge request power, when the control device sets the target power by imposing the limit. With the hybrid vehicle according to the aspect, by considering the air density of air taken into the engine or the difference between the charge/discharge request power of the power storage device and the actual charge/discharge request power, and hence considering whether or not the forced charging of the power storage device is requested, it is possible to more appropriately determine whether to notify that the output is insufficient.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a configuration view schematically illustrating a configuration of a hybrid vehicle 20 according to an embodiment of the present disclosure;

FIG. 2 is a flowchart showing an example of a target operation point setting routine executed by a hybrid vehicle electronic control unit (HVECU) 70;

FIG. 3 is a view illustrating an example of a map for an allowable upper limit power setting;

FIG. 4 is a view illustrating an example of a relationship among a deposition amount Qpm of particulate matter (PM), a filter temperature Tf, and a filter damage area;

FIG. 5 is a view illustrating an example of an operation line of an engine 22 and a mode of setting a temporary target engine speed Netmp;

FIG. 6 is a view illustrating an example of a map for an allowable upper limit engine speed setting;

FIG. 7 is an explanatory diagram illustrating an example of a relationship between an equal power line for a target power Pe* of the engine 22 and an equal air amount line for an intake air amount Qa of the engine 22;

FIG. 8 is a flowchart showing an example of a notification routine executed by the HVECU 70;

FIG. 9 is a flowchart showing an example of an allowable upper limit torque setting routine executed by the HVECU 70;

FIG. 10 is a view illustrating an example of the relationship between the upper and lower limit engine speeds Nemax(co) and Nemin(co) due to the performance of the engine 22 and the vehicle speed V;

FIG. 11 is a view illustrating an example of a map for an allowable upper limit torque setting;

FIG. 12 is a configuration view schematically illustrating a configuration of a hybrid vehicle 120 according to a modification example;

FIG. 13 is a flowchart showing an example of a transmission control routine executed by an HVECU 70;

FIG. 14 is a view illustrating an example of a map for an allowable lower limit gear stage setting; and

FIG. 15 is a configuration view schematically illustrating a configuration of a hybrid vehicle 220 according to a modification example.

### DETAILED DESCRIPTION OF EMBODIMENTS

Next, an embodiment for implementing the present disclosure will be described.

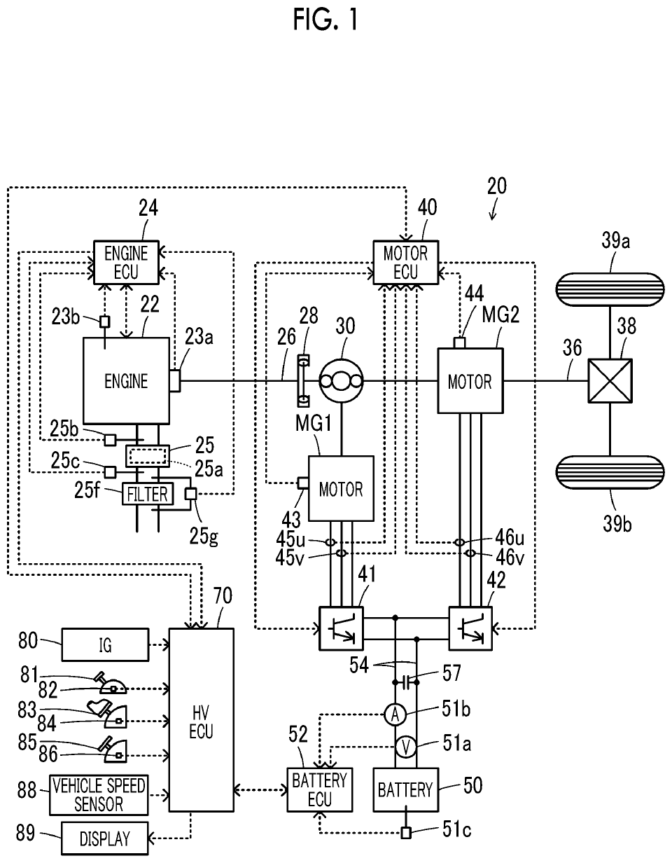

FIG. 1 is a configuration view schematically illustrating a configuration of a hybrid vehicle 20 according to an embodiment of the present disclosure. As illustrated in the figure, a hybrid vehicle 20 of the embodiment includes an engine 22, a planetary gear 30, motors MG1 and MG2, inverters 41 and 42, a battery 50 as a power storage device, and a hybrid vehicle electronic control unit (hereinafter referred to as “HVECU”) 70.

The engine 22 is an internal combustion engine that outputs power by using gasoline or diesel as a fuel, and is connected to a carrier of a planetary gear 30 through a damper 28. An exhaust gas control apparatus 25 and a particulate matter removal filter (hereinafter referred to as “PM filter”) 25f are attached to an exhaust system of the engine 22. The exhaust gas control apparatus 25 includes a catalyst 25a that removes unburned fuel and nitrogen oxides in the exhaust gas of the engine 22. The PM filter 25f is formed as a porous filter using ceramics, stainless steel, or the like, and captures particulate matter (PM) such as soot in the exhaust gas. The operation of the engine 22 is controlled by an engine electronic control unit (hereinafter referred to as “engine ECU”) 24.

Although not illustrated, the engine ECU 24 may include a microprocessor, mainly a central processing unit (CPU). In addition to the CPU, the engine ECU 24 includes a read only memory (ROM) that stores processing programs, a random access memory (RAM) that temporarily stores data, an input/output port, and a communication port. Signals from various sensors needed to control the operation of the engine 22 are input to the engine ECU 24 through an input port. Examples of signals input to the engine ECU 24 includes a crank angle θcr from a crank position sensor 23a detecting the rotational position of a crankshaft 26 of the engine 22, and the coolant temperature Tw from a coolant temperature sensor 23b detecting the temperature of the coolant of the engine 22. Further, an air-fuel ratio AF from an air-fuel ratio sensor 25b attached upstream of the exhaust gas control apparatus 25 in the exhaust system of the engine 22, and an oxygen signal O2 from an oxygen sensor 25c attached downstream of the exhaust gas control apparatus 25 in the exhaust system of the engine 22 may also be included in the examples. Furthermore, the differential pressure ΔP from the differential pressure sensor 25g detecting the differential pressure before and after the PM filter 25f (the differential pressure between the upstream side and the downstream side) may also be regarded as another example. Various control signals for controlling the operation of the engine 22 are output from the engine ECU 24 through an output port. The engine ECU 24 is connected to the HVECU 70 through the communication port.

The engine ECU 24 calculates the engine speed Ne of the engine 22 based on the crank angle θcr from the crank position sensor 23a, or calculates (estimates) the temperature Tc (catalyst temperature) of the catalyst 25a based on the coolant temperature Tw from the coolant temperature sensor 23b. In addition, the engine ECU 24 calculates a volumetric efficiency (ratio of the volume of air actually taken into the engine 22 in one cycle to the stroke volume in one cycle of the engine 22) KL based on the intake air amount Qa from an air flow meter (not shown) and the engine speed Ne of the engine 22. Furthermore, the engine ECU 24 calculates the deposition amount Qpm of PM as an deposition amount of particulate matter deposited on the PM filter 25f based on the differential pressure ΔP from the differential pressure sensor 25g, and calculates the filter temperature Tf as temperature of the PM filter 25f based on the engine speed Ne of the engine 22 and the volumetric efficiency KL.

The planetary gear 30 may be a single-pinion type planetary gear mechanism, and includes a sun gear, a ring gear, a plurality of pinion gears that meshes with the sun gear and the ring gear, and a carrier that rotatably and revolvably supports the plurality of pinion gears. The sun gear of the planetary gear 30 is connected to the rotor of a motor MG1. The ring gear of the planetary gear 30 is connected to a drive shaft 36 coupled to the drive wheels 39a, 39b through a differential gear 38. As described above, the crankshaft 26 of the engine 22 is connected to the carrier of the planetary gear 30 through the damper 28. Therefore, it can be said that the motor MG1, the engine 22, the drive shaft 36, and a motor MG2 are connected to the sun gear, the carrier, and the ring gear as three rotational elements of the planetary gear 30 such that the motor MG1, the engine 22, the drive shaft 36, and a motor MG2 are arranged in this order in a collinear diagram of the planetary gear 30.

The motor MG1 may be, for example, a synchronous generator motor, and the rotor is connected to the sun gear of the planetary gear 30 as described above. The motor MG2 may be, for example, a synchronous generator motor, and a rotor is connected to the drive shaft 36. Inverters 41, 42 are used to drive motors MG1, MG2 and are connected to battery 50 through power lines 54. A smoothing capacitor 57 is attached to the power lines 54. The motors MG1, MG2 are rotationally driven by switching control of a plurality of switching elements (not shown) of the inverters 41, 42 by a motor electronic control unit (hereinafter referred to as “motor ECU”) 40.

Although not illustrated, the motor ECU 40 may include a microprocessor, mainly a CPU. In addition to the CPU, the motor ECU 40 includes a ROM that stores processing programs, a RAM that temporarily stores data, an input/output port, and a communication port. Signals from various sensors needed to control the driving of the motors MG1, MG2 are input to the motor ECU 40 through the input port. Here, the examples of the signals include rotational positions θm1, θm2 from the rotational position detecting sensors 43, 44 detecting rotational positions of the rotors of the motors MG1, MG2, and phase currents Iu1, Iv1, Iu2, Iv2 from current sensors 45u, 45v, 46u, 46v detecting currents flowing in the phases of the motors MG1, MG2. From the motor ECU 40, switching control signals of a plurality of switching elements of the inverters 41, 42 are output through the output port. The motor ECU 40 is connected to the HVECU 70 through the communication port. The motor ECU 40 calculates the electrical angles θe1, θe2 and the angular velocities ωa1, ωm2, and the rotation speeds Nm1, Nm2 of the motors MG1, MG2, based on the rotational positions θm1, θm2 of the rotors of the motors MG1, MG2 from the rotational position detecting sensors 43, 44.

The battery 50 may be, for example, a lithium-ion secondary battery or a nickel hydride secondary battery, and is connected to the power lines 54. The battery 50 is managed by a battery electronic control unit (hereinafter referred to as “battery ECU”) 52.

Although not illustrated, the battery ECU 52 may include a microprocessor, mainly a CPU. In addition to the CPU, the battery ECU 52 includes a ROM that stores processing programs, a RAM that temporarily stores data, an input/output port, and a communication port. Signals from various sensors needed to manage the battery 50 are input to the battery ECU 52 through the input port. Examples of signals input to the battery ECU 52 includes the voltage Vb of the battery 50 from a voltage sensor 51a attached between the terminals of the battery 50 or the current Ib of the battery 50 from a current sensor 51b attached to the output terminal of the battery 50, and the temperature Tb of the battery 50 from a temperature sensor 51c attached to the battery 50. The battery ECU 52 is connected to the HVECU 70 through the communication port. The battery ECU 52 calculates the power storage ratio SOC based on the integrated value of the current Ib of the battery 50 from the current sensor 51b, or calculates input/output limits Win and Wout of the battery 50 based on the calculated power storage ratio SOC and the temperature Tb of the battery 50 from the temperature sensor 51c. The power storage ratio SOC is the ratio of the amount of power that can be discharged from the battery 50 to the total capacity of the battery 50, and the input/output limits Win and Wout are allowable input/output electric power that may charge/discharge the battery 50.

Although not illustrated, the HVECU 70 may include a microprocessor, mainly a CPU. In addition to the CPU, the HVECU 70 includes a ROM that stores processing programs, a RAM that temporarily stores data, an input/output port, and a communication port. Signals from various sensors are input to the HVECU 70 through the input port. Examples of the signals input to the HVECU 70 include an ignition signal from an ignition switch 80 and a shift position SP from a shift position sensor 82 detecting the operation position of a shift lever 81. Further, the accelerator operation amount Acc from an accelerator pedal position sensor 84 detecting the depression amount of the accelerator pedal 83, the brake pedal position BP from a brake pedal position sensor 86 detecting the depression amount of the brake pedal 85, and the vehicle speed V from a vehicle speed sensor 88 can be also included by way of example. From the HVECU 70, a control signal to a display 89 that displays various types of information or the like, is output through the output port. As described above, the HVECU 70 is connected to the engine ECU 24, the motor ECU 40, and the battery ECU 52 through the communication port.

The hybrid vehicle 20 of the embodiment configured as described above travels in a hybrid travel mode (HV travel mode) where traveling is performed with the engine 22 being rotated or an electric travel mode (EV travel mode) where traveling is performed with the rotating of the engine 22 being stopped.

When the accelerator is operated in the HV travel mode, the HVECU 70 sets the traveling torque Td* needed to travel (needed for the drive shaft 36) based on the accelerator operation amount Acc and the vehicle speed V, and calculate the traveling power Pd* needed to travel by multiplying the set traveling torque Td* by the rotation speed Nd of the drive shaft 36 (the rotation speed Nm2 of the motor MG2). Subsequently, the HVECU 70 calculates the requested power Petag needed for the engine 20 by subtracting the charge/discharge request power Pb* of the battery 50 (a positive value when discharging from the battery 50) from the traveling power Pd*, set the target power Pe* of the engine 22 based on the calculated requested power Petag of the engine 22, and sets the target engine speed Ne* and the target torque Te* as target operating points of the engine 22 such that the target power Pe* is output from the engine 22. A method of setting the target power Pe*, the target engine speed Ne*, and the target torque Te* of the engine 22 will be described in detail later.

Next, the HVECU 70 sets the torque command Tm1* of the motor MG1 such that the engine speed Ne of the engine 22 is the target engine speed Ne* within the range of the input/output limits Win and Wout of the battery 50, and sets the torque command Tm2* of the motor MG2 based on the traveling torque Td* and the torque command Tm1* of the motor MG1 such that the traveling torque Td* (traveling power Pd*) is output to the drive shaft 36. Then, the HVECU 70 transmits the target engine speed Ne* and target torque Te* of the engine 22 to the engine ECU 24, and transmits torque commands Tm1* and Tm2* of the motors MG1 and MG2 to the motor ECU 40. When the engine ECU 24 receives the target engine speed Ne* and the target torque Te* of the engine 22, the engine ECU 24 controls the operation of the engine 22 (intake air amount control, fuel injection control, ignition control, and the like) such that the engine 22 is operated based on the target engine speed Ne* and the target torque Te*. When motor ECU 40 receives torque commands Tm1*, Tm2* of motors MG1, MG2, switching control of switching elements of inverters 41, 42 is performed such that motors MG1, MG2 are driven by torque commands Tm1*, Tm2*.

When the accelerator is not operated in the HIV travel mode, the HVECU 70 sets the traveling torque Td* (basically a negative value) based on the vehicle speed V, and sets the torque commands Tm1*, Tm2* of motors MG1, MG2 such that the traveling torque Td* is output to the drive shaft 36 within the range of the input/output limits Win and Wout of the battery 50 by fuel cut of the engine 22, motoring of the engine 22 by the motor MG1, and regenerative driving of the motor MG2, or by autonomous operation of the engine 22 and regenerative driving of the motor MG2. Then, the HVECU 70 transmits the fuel cut command or the autonomous operation command of the engine 22 to the engine ECU 24, and transmits torque commands Tm1* and Tm2* of the motors MG1 and MG2 to the motor ECU 40. When the engine ECU 24 receives the fuel cut command, the engine ECU 24 stops the fuel injection control and the ignition control of the engine 22, and when the engine ECU 24 receives the autonomous operation command, the engine ECU 24 controls the operation of the engine 22 such that the engine 22 is autonomously operated. The control of the inverters 41, 42 by the motor ECU 40 has been described above.

In the EV travel mode, the HVECU 70 sets the traveling torque Td* based on the accelerator operation amount Ace and the vehicle speed V, sets the torque command Tm1* of the motor MG1 to a value of zero (0), sets the torque command Tm2* of the motor MG2 such that the traveling torque Td* is output to the drive shaft 36 within the range of the input/output limits Win and Wout of the battery 50, and transmits torque commands Tm1*, Tm2* of motors MG1, MG2 to motor ECU 40. The control of the inverters 41,42 by the motor ECU 40 has been described above.

Further, in the hybrid vehicle 20 of the embodiment, in a case where a filter regeneration condition for regenerating the PM filter 25f is satisfied in the HV travel mode, when the accelerator is not operated and the fuel cut of the engine 22 (and motoring of the engine 22 by the motor MG1) is performed, air (oxygen) is supplied to the PM filter 25f and the particulate matter deposited on the PM filter 25f burns. In this way, the PM filter 25f is regenerated. Here, as the filter regeneration condition, a condition in which the deposition amount Qpm of PM is equal to or higher than the threshold value Qpmref1 and the filter temperature Tf of the PM filter 25f is equal to or higher than the threshold value Tfref is used. The threshold value Qpmref is a threshold value for determining whether or not the regeneration of the PM filter 25f is needed. For example, 3 g/L, 4 g/L, 5 g/L, or the like is used. The threshold value Tfref is a threshold value for determining whether or not the filter temperature Tf has reached a reproducible temperature suitable for regeneration of the PM filter 25f. For example, 580° C., 600° C., 620° C., or the like is used.

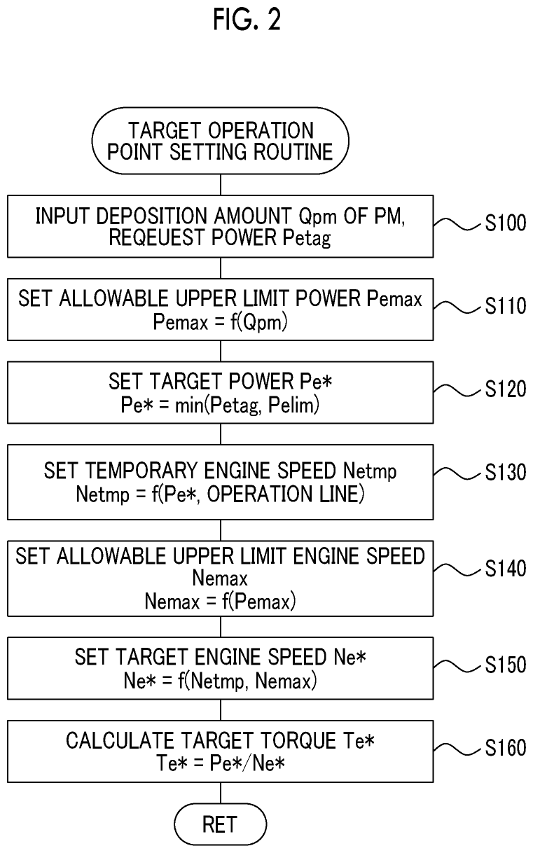

Next, the operation of the hybrid vehicle 20 of the embodiment configured as described above, particularly the operation at the time of setting the target engine speed Ne* and the target torque Te* as target operating points of the engine 22 will be described. FIG. 2 is a flowchart showing an example of a target operation point setting routine executed by the HVECU 70. The routine is repeatedly executed when the accelerator is operated in the HV travel mode.

When the target operation point setting routine of FIG. 2 is executed, the HVECU 70 first inputs data such as the deposition amount Qpm of PM and the requested power Petag of the engine 22 (step S100). Here, a value calculated by the engine ECU 24 is input as the deposition amount Qpm of PM by communication. As described above, as the request power Petag of the engine 22, a value is input which is set based on the traveling power Pd* based on the accelerator operation amount Ace and the vehicle speed V and the charge/discharge request power Pb* of the battery 50.

When data is input as described above, an allowable upper limit power Pemax of the engine 22 is set based on the input deposition amount Qpm of PM (step S110), and the target power Pe* of the engine 22 is set by limiting the requested power Petag of the engine 22 to the allowable upper limit power Pemax (upper limit guard) (step S120).

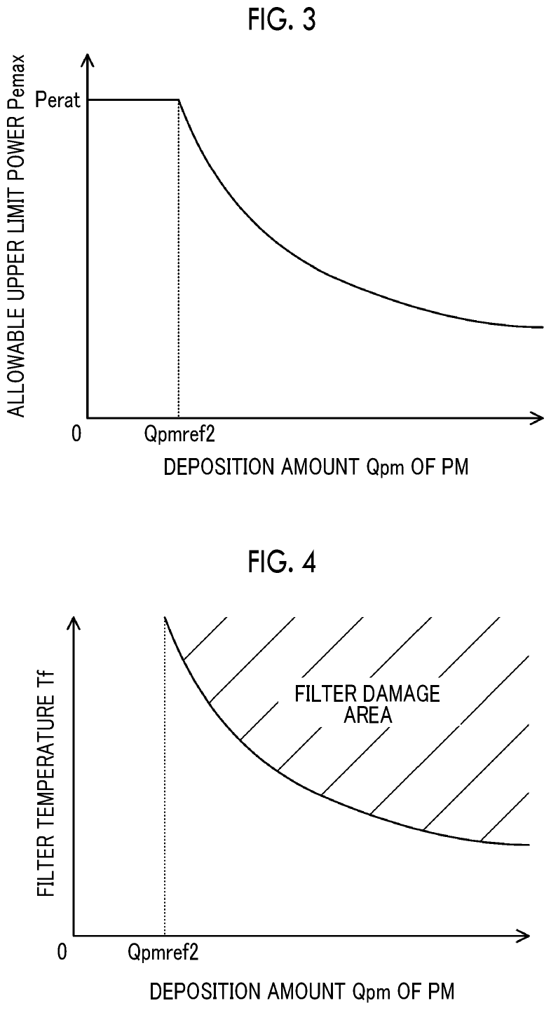

Here, in the embodiment, the allowable upper limit power Pemax of the engine 22 can be stored as a map for an allowable upper limit power setting in a ROM (not shown) by predetermining a relationship between the deposition amount Qpm of PM and the allowable upper limit power Pemax. When the deposition amount Qpm of PM is given, the corresponding allowable upper limit power Pemax is derived from the map. FIG. 3 is a view illustrating an example of the map for the allowable upper limit power setting. As shown in the figure, the allowable upper limit power Pemax is set to the rated output Perat of the engine 22 in a region where the deposition amount Qpm of PM is less than the threshold value Qpmref2, and is set to be smaller as the deposition amount Qpm of PM increases within the range less than the rated output Perat of the engine 22, in a region where the deposition amount Qpm of PM is equal to or greater than the threshold value Qpmref2. The threshold value Qpmref2 is determined as the upper limit of the deposition amount Qpm of PM that would not cause damage of the PM filter 25f even if the fuel cut of the engine 22 is subsequently performed, and a value that is the same as or slightly smaller than the threshold value Qpmref1 is used.

Hereinafter, the reason why the allowable upper limit power Pemax of the engine 22 is set to the tendency as illustrated in FIG. 3 will be described. FIG. 4 is a view illustrating an example of a relationship among the deposition amount Qpm of PM, the filter temperature Tf, and an area in which the PM filter 25f is likely to be damaged (hereinafter referred to as “filter damage area”). Through experiments and analysis, the inventors have shown that, in the area where the deposition amount Qpm of PM is equal to or greater than the threshold value Qpmref2, the filter damage area expands toward the lower temperature Tf of the filter as the deposition amount Qpm of PM increases, as illustrated in the figure. It has been also shown that when the fuel cut of the engine 22 is performed, the filter temperature Tf is likely to be high as compared to when the fuel injection of the engine 22 is performed, due to the burning of particulate matter deposited on the PM filter 25f. Furthermore, it has been shown that when the fuel injection of the engine 22 is performed, the output of the engine 22 increases as the intake air amount Qa of the engine 22 increases, and the filter temperature Tf tends to be high. Accordingly, in controlling the engine 22, the allowable upper limit power Pemax of the engine 22 is set to have the tendency as in FIG. 3, that is, to decrease as the deposition amount Qpm of PM increase in the area where the deposition amount Qpm of PM is equal to or greater than the threshold value Qpmref2, and the target power Pe* of the engine 22 is set with the upper limit of the requested power Petag of the engine 22 being guarded with the set allowable upper limit power Pemax. In this way, it is possible to suppress the filter temperature Tf so as not to reach the filter damage area and to suppress damage of the PM filter 25f, when subsequent fuel cut of the engine 22 is performed. The fuel cut of the engine 22 is performed together with the motoring of the engine 22 by the motor MG1 when the accelerator is not operated, for example.

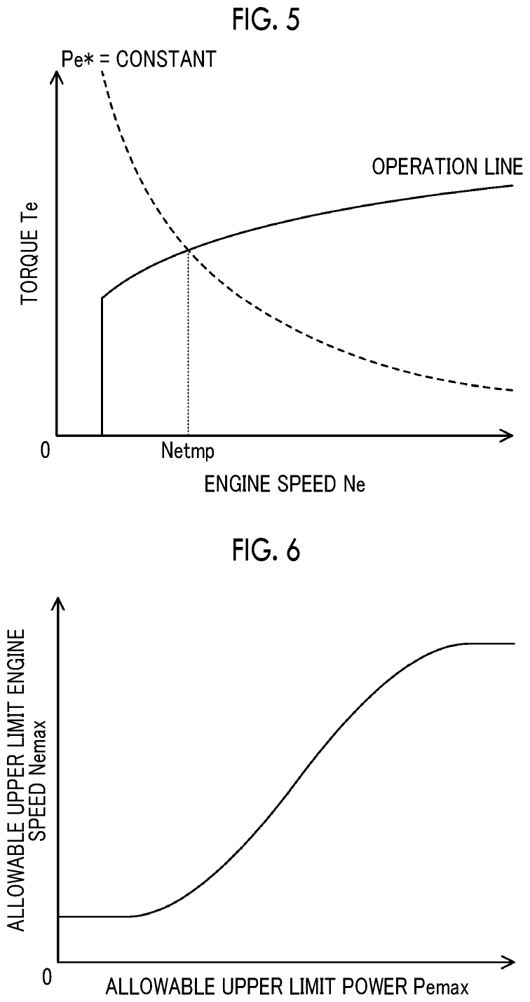

When the target power Pe* of the engine 22 is set in step S120, a temporary target engine speed Netmpa is set as a temporary value of the target engine speed Ne* of the engine 22, based on the set target power Pe* of the engine 22 and an operation line for efficiently operating the engine 22 (step S130). FIG. 5 is a view illustrating an example of the operation line of the engine 22 and a mode of setting the temporary target engine speed Netmp. The processing for setting the temporary target engine speed Netmp of the engine 22 is performed by setting the engine speed Ne 1 at the intersection of a curve with a constant target power Pe* of the engine 22 and the operation line of the engine 22, as the temporary engine speed Netmp.

Subsequently, the allowable upper limit engine speed Nemax of the engine 22 is set based on the allowable upper limit power Pemax of the engine 22 (step S140), the target engine speed Ne* of the engine 22 is set by limiting the temporary target engine speed Netmp of the engine 22 to the allowable upper limit engine speed Nemax (upper limit guide) (step S150), and the target torque Te* of the engine 22 is calculated by dividing the target power Pe* of the engine 22 by the target engine speed Ne* of the engine 22 (step S160). Then, the routine ends.

Here, in the embodiment, the allowable upper limit engine speed Nemax of the engine 22 can be stored as a map for an allowable upper limit engine speed setting in a ROM (not shown) by predetermining relationship between the allowable upper limit power Pemax and the allowable upper limit engine speed Nemax. When the allowable upper limit power Pemax is given, the corresponding allowable upper limit engine speed Nemax is derived from the map and set. FIG. 6 is a view illustrating an example of the map for the allowable upper limit engine speed setting. As illustrated in the figure, the allowable upper limit engine speed Nemax of the engine 22 is set to be smaller as the allowable upper limit power Pemax of the engine 22 is small.

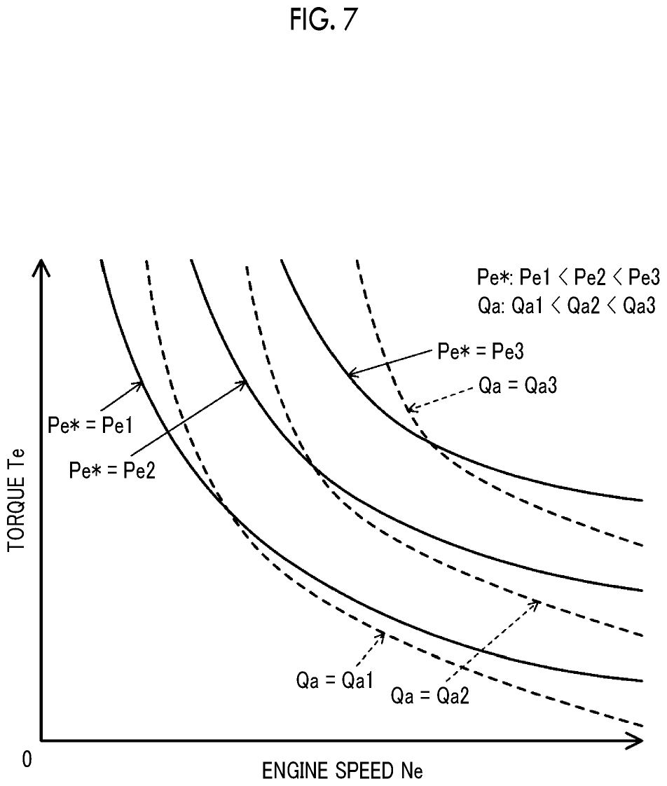

Hereinafter, the reason why the allowable upper limit engine speed Nemax of the engine 22 is set to the tendency as illustrated in FIG. 6 will be described. FIG. 7 is an explanatory diagram illustrating an example of a relationship between an equal power line for the target power Pe* of the engine 22 and an equal air amount line for the intake air amount Qa of the engine 22. Through experiments and analysis, the inventors have shown that the intake air amount Qa needed to output the same power increases as the engine speed Ne of the engine 22 increases, as illustrated in the figure. As described above, as the intake air amount Qa of the engine 22 increases, the filter temperature Tf tends to be high. Accordingly, the allowable upper limit engine speed Nemax is set to have the tendency as in FIG. 6, that is, to decrease as the allowable upper limit power Pemax of the engine 22 decreases. In this way, it is possible to suppress increase in the filter temperature Tf when the target power Pe* is output from the engine 22.

In the hybrid vehicle 20 of the embodiment described above, to control the engine 22, the allowable upper limit power Pemax of the engine 22 is set to be small when the deposition amount Qpm of PM is equal to or greater than the threshold value Qpmref2 as compared to when the deposition amount Qpm of PM is less than the threshold value Qpmref2, and the target power Pe* of the engine 22 is set within the range of the allowable upper limit power Pemax of the engine 22 or less based on the traveling power Pd*. In this way, when subsequent fuel cut of the engine 22 is performed, it is possible to suppress the filter temperature Tf so as not to reach the filter damage area, and to suppress damage of the PM filter 25f.

In the hybrid vehicle 20 of the embodiment, when the deposition amount Qpm of PM is equal to or greater than the threshold value Qpmref2, the allowable upper limit power Pemax is set to decrease as the deposition amount Qpm of PM increases within the range less than rated output Perat of the engine 22. However, when the deposition amount Qpm of PM is equal to or greater than the threshold value Qpmref2, a uniform value may be used regardless of the deposition amount Qpm of PM as long as the allowable upper limit power Pemax is within the range less than the rated output Perat of the engine 22.

In the hybrid vehicle 20 of the embodiment, the allowable upper limit power Pemax of the engine 22 is set to be small when the deposition amount Qpm of PM is equal to or greater than the threshold value Qpmref2 as compared to when the deposition amount Qpm of PM is less than the threshold value Qpmref2, and the target power Pe* of the engine 22 is set by limiting the requested power Petag of the engine 22 to the allowable upper limit power Pemax (upper guide). However, when the deposition amount Qpm of PM is less than the threshold value Qpmref2, the requested power Petag of the engine 22 may be set to the target power Pe*, and when the deposition amount Qpm of PM is equal to or greater than the threshold value Qpmref2, a value obtained by multiplying the requested power Petag of the engine 22 by a correction coefficient kp smaller than 1 may be set to the target power Pe* of the engine 22. In this case, the coefficient kp may be determined to decrease as the deposition amount Qpm of PM increases, or may take a uniform value to be used regardless of the deposition amount Qpm of PM.

In the hybrid vehicle 20 of the embodiment, the allowable upper limit engine speed Nemax of the engine 22 is set to decrease as the allowable upper limit power Pemax of the engine 22 decreases. However, a uniform value may be used as the allowable upper limit engine speed Nemax of the engine 22, regardless of the allowable upper limit power Pemax. of the engine 22.

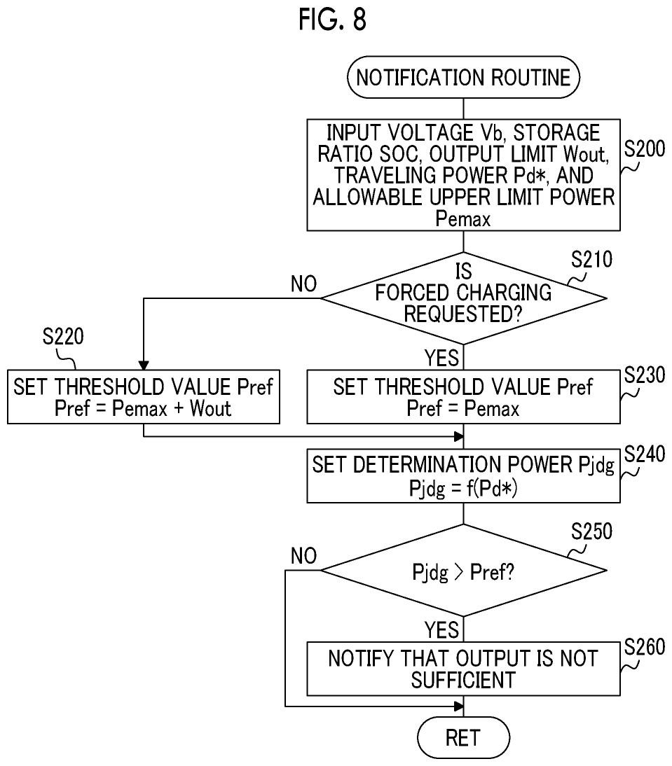

Although not described in the hybrid vehicle 20 of the embodiment, the HVECU 70 may repeatedly execute a notification routine of FIG. 8 in parallel with the routine described above, when the allowable upper limit power Pemax of the engine 22 set in the target operation point setting routine of FIG. 2 is smaller than the rated output Perat.

When the notification routine of FIG. 8 is executed, the HVECU 70 first inputs the voltage Vb of the battery 50, the power storage ratio SOC, the output limit Wout, and the allowable upper limit power Pemax of the engine 22 (step S200). Here, a value detected by the voltage sensor 51a is input as the voltage Vb of the battery 50. Values calculated by the battery ECU 52 are input as the power storage ratio SOC and the output limit Wout of the battery 50 by communication. A value set based on the accelerator operation amount Ace and the vehicle speed V as described above is input as the traveling power Pd*. A value set by the target operation point setting routine of FIG. 2 is input as the allowable upper limit power Pemax of the engine 22.

When data is input as described above, determination is made whether or not a forced charging of the battery 50 is requested using the input voltage Vb and the power storage ratio SOC of the battery 50 (step S210). The determination processing is performed, for example, by comparing the voltage Vb of the battery 50 to an allowable lower limit voltage Vbmin and comparing the power storage ratio SOC of the battery 50 to an allowable lower limit ratio Slo. As the allowable lower limit voltage Vbmin of the battery 50, a value sufficiently lower than the rated voltage Vbrat of the battery 50 is used, and as the allowable lower limit ratio Slo of the battery 50, for example, 30%, 35%, 40% or the like is used.

When the forced charging of the battery 50 is requested, a sufficiently small value (large in terms of the absolute value) within a negative range is set for the charge/discharge request power Pb* of the battery 50, and the requested power Petag of the engine 22 is made sufficiently larger than the traveling power Pd*. Thus, on condition that the allowable upper limit power Pemax of the engine 22 is larger than the traveling power Pd*, the target power Pe* of the engine 22, that is, the power from the engine 22 becomes larger than the traveling power Pd*, and the battery 50 is forcibly charged. As a result, over-discharge of the battery 50 can be suppressed.

When the forced charging of the battery 50 is not requested in step S210, the sum of the allowable upper limit power Pemax of the engine 22 and the output limit Wout of the battery 50 is set to the threshold value Pref to be used for determining whether or not traveling is possible by outputting the traveling power Pd* to the drive shaft 36 (step S220), and when the forced charging of the battery 50 is requested, the allowable upper limit power Pemax of the engine 22 is set to the threshold value Pref (step S230). This is because in the former, the battery 50 may be discharged within the range of the output limit Wout of the battery 50, while in the latter, the battery 50 may not be discharged.

Subsequently, the determination power Pjdg is set based on the traveling power Pd* (step S240). Here, the determination power Pjdg can be calculated, for example, by correcting the traveling power Pd* by using a correction value α1 based on the intake air density of air taken into the engine 22 and a correction value a2 based on the difference ΔPb between the charge/discharge request power Pb* of the battery 50 and the actual charge/discharge power Pb, as expressed in Equation 1. The correction value α1 is used since the output of the engine 22 varies with respect to the same target power Pe* depending on the air density of the intake air of the engine 22 (depending on temperature and altitude) and the variation affects the power output to the drive shaft 36. The correction value α2 is used since the difference ΔPb between the charge/discharge request power Pb* of the battery 50 and the actual charge/discharge power Pb affects the power output to the drive shaft 36.

Pjdg=Pd*α1+α2 (1)

Next, the determination power Pjdg is compared to the determination threshold value Pref (step S250). When the determination power Pjdg is larger than the threshold value Pref, determination is made that traveling is not possible by outputting the traveling power Pd* to the drive shaft 36, and an indication that the output is insufficient based on the allowable upper limit power Pemax of the engine 22 being smaller than the rated output Perat is displayed on the display 89 (step S260). Then, the routine ends. In this way, it is possible to notify a driver that the output is insufficient based on the allowable upper limit power Pemax of the engine 22 being smaller than the rated output Perat.

When the determination power Pjdg is equal to or less than the threshold value Pref in step S250, determination is made that traveling is possible by outputting the traveling power Pd* to the drive shaft 36, and the indication that the output is insufficient is not displayed on the display 89. Then, the routine ends. In this way, when the allowable upper limit power Pemax of the engine 22 is smaller than the rated output Perat, it is possible to suppress excessive frequency of notification of insufficient output as compared to notification of insufficient output regardless of the traveling power Pd* and the determination power Pjdg.

As a modification example, it is assumed that, when the allowable upper limit power Pemax of the engine 22 is smaller than the rated output Perat and the determination power Pjdg is larger than the threshold value Pref, notification of insufficient output is issued, and when the determination power Pjdg is equal to or less than the threshold value Pref, notification of insufficient output is not issued. Instead, when the allowable upper limit power Pemax of the engine 22 is smaller than the rated output Perat, notification that the allowable upper limit power Pemax of the engine 22 is made smaller than the rated output Perat regardless of the traveling power Pd* and the determination power Pjdg (and thus it is likely that insufficient output occurs) may be issued.

In the modification example, the determination power Pjdg is set by correcting the traveling power Pd* using the correction values α1, α2. However, the determination power Pjdg may be set by correcting the traveling power Pd* using just one of the correction values α1, α2, or the traveling power Pd* may be set to the determination power Pjdg as it is.

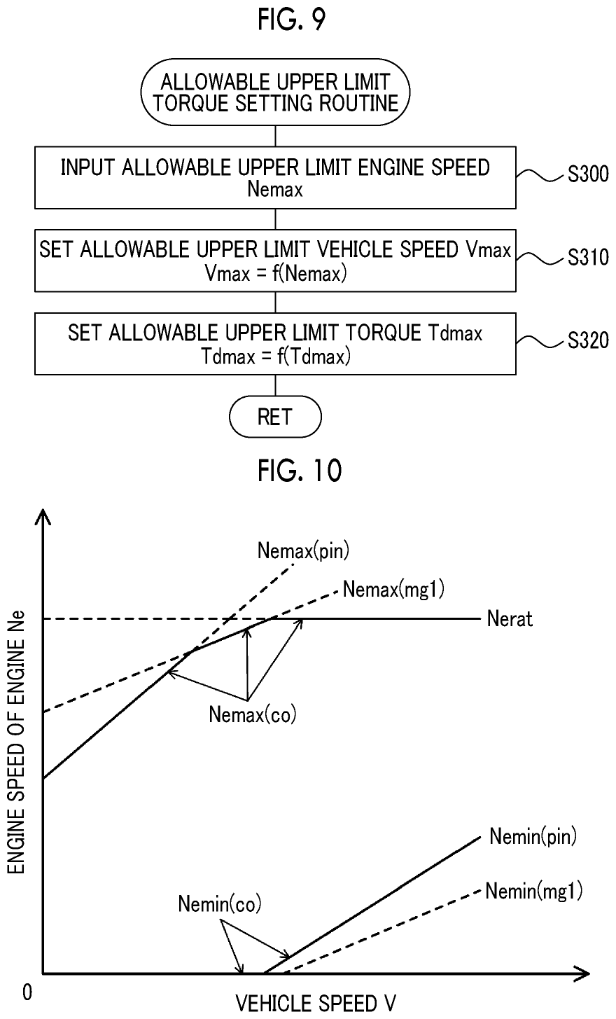

Although not described in the hybrid vehicle 20 of the embodiment, the HVECU 70 may execute an allowable upper limit torque setting routine of FIG. 9 in parallel with the target operation point setting routine of FIG. 2. The routine is repeatedly executed in the HV travel mode.

When the allowable upper limit torque setting routine of FIG. 9 is executed, the HVECU 70 first input the allowable upper limit engine speed Nemax of the engine 22, which has been set in the target operation point setting routine of FIG. 2 (step S300), and sets the allowable upper limit vehicle speed Vmax based on the input allowable upper limit engine speed Nemax of the engine 22 (step S310). FIG. 10 illustrates an example of the relationship between the upper and lower limit engine speeds (hereinafter referred to as ‘upper and lower limit engine speeds due to performance’) Nemax(co), Nemin(co) of the engine 22, which are based on the performance of the engine 22, the motor MG1, and the pin gear of the planetary gear 30, and the vehicle speed V.

As illustrated in the figure, among the rated engine speed Nerat of the engine 22, the upper limit engine speed Nemax(mg 1) of the engine 22 based on the performance of the motor MG1, and the upper limit engine speed Nemax(pin) of the engine 22 based on the performance of the pinion gear of the planetary gear 30, the minimum value is set to the upper limit engine speed Nemax(co) of the engine 22 due to performance. Here, the upper limit engine speed Nemax(mg1) of the engine 22 based on the performance of the motor MG1 and the vehicle speed V have the relationship of Equation 2, when the rated rotation speed Nm1rat1 of the motor MG1 on the positive side, a gear ratio ρ of the planetary gear 30 (number of teeth of the sun gear/number of teeth of the ring gear), and a conversion factor kv for converting the vehicle speed V into the rotation speed Nd of the drive shaft 36 are used. Further, the upper limit engine speed Nemax(pin) of the engine 22 based on the performance of the pinion gear of the planetary gear 30 and the vehicle speed V have the relationship of equation (3), when the rated rotation speed Npinrat1 of the pinion gear on the positive side, a gear ratio γ of the planetary gear 30 to the pinion gear 33, and the conversion coefficient kv are used.

Ne max(mg1)=ρ−Nm1rat1/(1+φ+V·k/(1+φ (2)

Ne max(pin)=V·k+γ·Npinrat1 (3)

Further, as illustrated in the figure, among the value zero (0), the lower limit engine speed Nemin(mg1) of the engine 22 based on the performance of the motor MG1, and the lower limit engine speed Nemin(pin) of the engine 22 based on the pinion gear of the planetary gear 30, the maximum value is set to the lower limit engine speed due to performance Nemin(co) of the engine 22. Here, the lower limit engine speed Nemin(mg1) of the engine 22 based on the performance of the motor MG1 and the vehicle speed V have the relationship of Equation 4, when the rated rotation speed Nm1rat2 of the motor MG1 on the negative side, a gear ratio ρ of the planetary gear 30, and the conversion factor kv are used. Further, the vehicle speed V and the lower limit engine speed Nemin(pin) of the engine 22 based on the performance of the pinion gear of the planetary gear 30 has the relationship of equation (5), when the rated rotation speed Npinrat2 of the pinion gear on the negative side, a gear ratio γ of the planetary gear 30 with respect to the pinion gear 33, and the conversion coefficient kv are used.

Ne min(mg1)=ρ·Nm1rat2/(1+p)+V·k/(1+ρ) (4)

Ne min(pin)=V·k+γ·Npinrat2 (5)

In the processing of step S310, using input the allowable upper limit engine speed Nemax of the engine 22, which has been set in the target operation point setting routine of FIG. 2 (has been input in step S300) and FIG. 10, the intersection between the allowable upper limit engine speed Nemax and the lower limit engine speed Nemin(co) due to performance of the engine 22 is set to the allowable upper limit vehicle speed Vmax. In this way, based on the performance of the motor MG1 and the pinion gear of the planetary gear 30, the allowable upper limit vehicle speed Vmax can be set within a range in which over-speeds thereof can be suppressed.

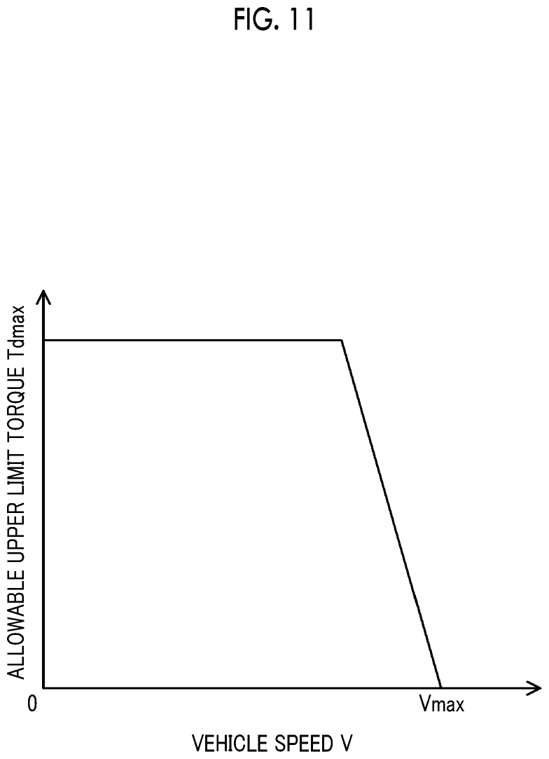

When the allowable upper limit vehicle speed Vmax is set as described above, the allowable upper limit torque Tdmax is set based on the set allowable upper limit vehicle speed Vmax (step S320). Then, the routine ends. Here, in the modification example, the allowable upper limit torque Tdmax can be stored as a map for an allowable upper limit torque setting in a ROM (not shown) by predetermining relationship between the allowable upper limit vehicle speed Vmax and the allowable upper limit torque Tdmax. When the allowable upper limit vehicle speed Vmax is given, the corresponding allowable upper limit torque Tdmax is derived from the map and set. FIG. 11 is a view illustrating an example of the map for the allowable upper limit torque setting. As shown in the figure, the allowable upper limit torque Tdmax is set to decrease as the vehicle speed V increases. When the allowable upper limit torque Tdmax is set as described above, the traveling torque Td* is set within the range of the allowable upper limit torque Tdmax or less based on the accelerator operation amount Ace and the vehicle speed V. In this way, it is possible to suppress the vehicle speed V so as not to exceed the allowable upper limit vehicle speed Vmax, by limiting the traveling torque Td* according to the vehicle speed V. As a result, the excessive rotation of the motor MG1 and the pinion gear of the planetary gear 30 can be suppressed.

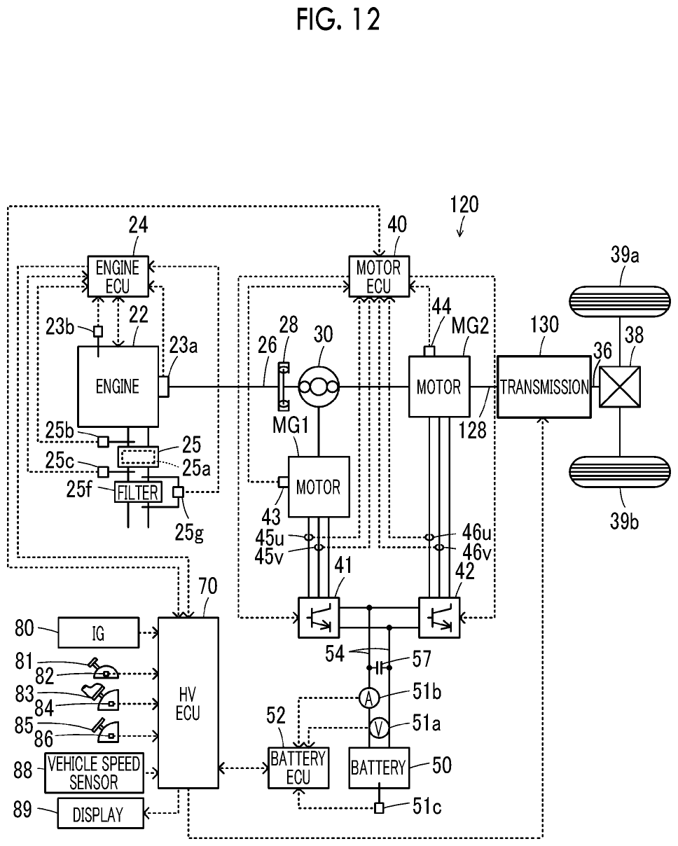

In the hybrid vehicle 20 of the embodiment, the planetary gear 30 and the motor MG2 are connected to the drive shaft 36 connected to the drive wheels 39a, 39b. However, as illustrated in the hybrid vehicle 120 of the modification example of FIG. 12, a transmission 130 may be provided between the drive shaft 36 and an intermediate shaft 128 to which the planetary gear 30 and the motor MG2 are connected.

The transmission 130 has an input shaft, an output shaft, a plurality of planetary gears, and a plurality of friction engagement elements (clutch and brake) that are hydraulically driven. The input shaft is connected to the intermediate shaft 128 and the output shaft is connected to the drive shaft 36. The transmission 130 forms forward and reverse stages ranging from first gear to fifth gear by engaging and disengaging the engagement elements and transmits power the input shaft and the output shaft. The transmission 130 is controlled by the HVECU 70.

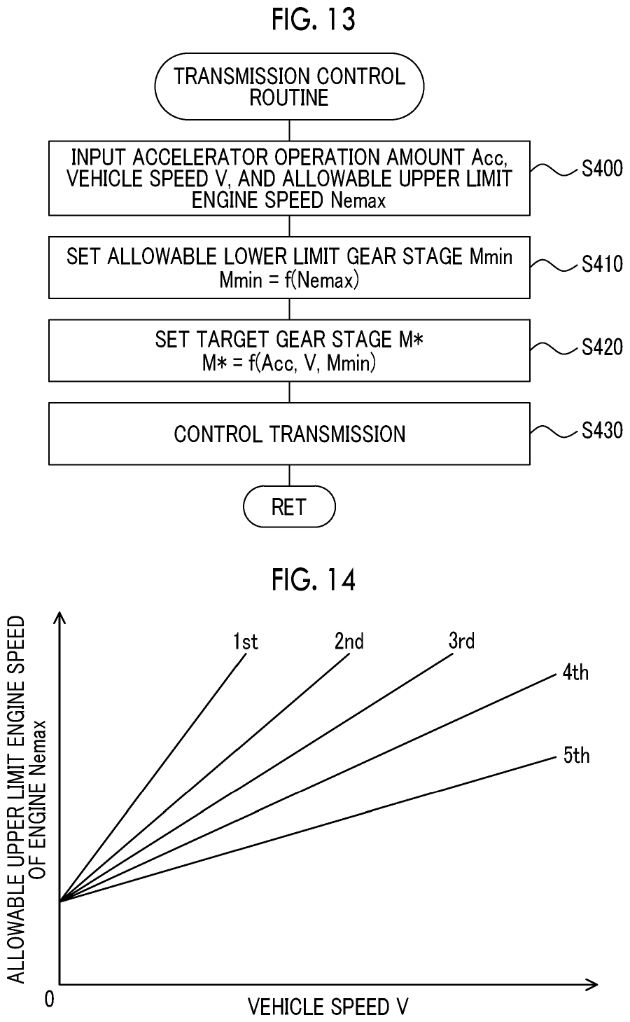

In the hybrid vehicle 120 of the modification example, the HVECU 70 may execute a transmission control routine of FIG. 13 in parallel with the target operation point setting routine of FIG. 2, instead of the allowable upper limit torque setting routine of FIG. 9.

When the transmission control routine of FIG. 13 is executed, the HVECU 70 first inputs data such as the accelerator operation amount Ace, the vehicle speed V, and the allowable upper limit engine speed Nemax of the engine 22 (step S400). A value detected by the accelerator pedal position sensor 84 is input as the accelerator operation amount Ace. A value detected by the vehicle speed sensor 88 is input as the vehicle speed V. A value set in the target operation point setting routine of FIG. 2 is input as the allowable upper limit engine speed Nemax of the engine 22.

When the data is input as described above, the allowable lower limit gear stage Mmin of the transmission 130 is set based on the input vehicle speed V and the allowable upper limit engine speed Nemax of the engine 22 (step S410), the target gear stage M* of the transmission 130 is set within the range equal to or greater than the allowable lower limit gear stage Mmin based on the accelerator operation amount Acc and the vehicle speed V (step S420), and the transmission 130 is controlled such that the gear stage M of the transmission 130 is the target gear stage M* (step S430). Then, the routine ends.

Here, in the modification example, the allowable lower limit gear stage Mmin of the transmission 130 can be stored as a map for an allowable lower limit gear stage setting in a ROM (not shown) by predetermining the relationship between the vehicle speed V and the allowable upper limit engine speed Nemax of the engine 22 and the allowable lower limit gear stage Mmin of the transmission 130. When the vehicle speed V and the allowable upper limit engine speed Nemax of the engine 22 are given, the corresponding allowable lower limit gear stage Mmin of the transmission 130 is derived from the map and set. FIG. 14 is a view illustrating an example of the map for the allowable lower limit gear stage setting. As illustrated in the figure, the allowable lower limit gear stage Mmin of the transmission 130 is set such that the higher the vehicle speed V, the higher the gear stage, and the lower the allowable lower limit engine speed Nemin of the engine 22, the higher the gear stage. This is because the higher the gear stage M of the transmission 130 is, the lower the rotation speed of the intermediate shaft 128 is for the same vehicle speed, and the allowable lower limit engine speed Nemin of the engine 22 is allowed to be lowered when the ‘vehicle speed V’ on the horizontal axis in FIG. 10 is replaced with ‘the rotation speed Nin of the intermediate shaft 128’. By setting the target gear stage M* of the transmission 130 within the range equal to or greater than the allowable lower limit gear stage Mmin of the transmission 130, as described above and controlling the transmission 130, it is possible to suppress excessive rotation of the motor MG1 and the pinion gear of the planetary gear 30 as in the case of executing the allowable upper limit torque setting routine of FIG. 9.

In the modification example, a 10-gear stage transmission is used as the transmission 130, but an applicable embodiment of the present disclosure is not limited thereto. Transmissions of a 4-gear stage, 5-gear stage, 6-gear stage, 8-gear stage, and so on, may be used.

In the hybrid vehicle 20 of the embodiment, the battery 50 is used as the power storage device. However, a capacitor may be used instead of the battery 50.

Although the hybrid vehicle 20 of the embodiment includes the engine ECU 24, the motor ECU 40, the battery ECU 52, and the HVECU 70, at least two of the ECUs may be configured as a single electronic control unit.

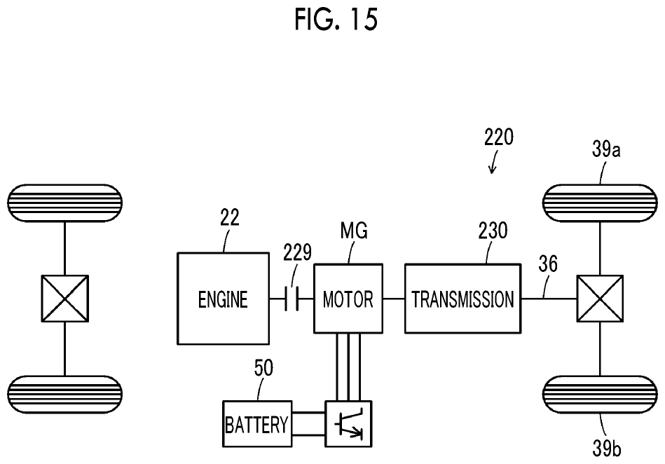

The hybrid vehicle 20 of the embodiment has the configuration in which the engine 22 and the motor MG1 are connected to the drive shaft 36 connected to the drive wheels 39a, 39b through the planetary gear 30, the motor MG2 is connected to the drive shaft 36, and the battery 50 is connected to the motors MG1 and MG2 through the power lines. However, as illustrated in a modification example in FIG. 15, a hybrid vehicle 220 may have a configuration in which a motor MG is connected to the drive shaft 36 connected to the drive wheels 39a, 39b through a transmission 230, the engine 22 is connected to the motor MG through a clutch 229, and the battery 50 may be connected to the motor MG through power lines.

The correspondence between the main elements of the embodiment and the main elements of the present disclosure described in the Summary section will be described. In the embodiment, the engine 22 corresponds to the “engine”, the motor MG1 corresponds to the “motor”, the battery 50 corresponds to the “power storage device”, and the HVECU 70, the engine ECU 24, and the motor ECU 40 correspond to the “control device”. Further, the planetary gear 30 corresponds to a “planetary gear”, and the motor MG2 corresponds to a “second motor”. In addition, the transmission 130 corresponds to a “transmission”.

The correspondence between the main elements of the embodiment and the main elements of the present disclosure described in the Summary section is not construed to limit elements of the present disclosure described in the Summary section, since embodiment is an example to specifically describe the mode for carrying out the present disclosure described in the Summary section. That is, the interpretation of the present disclosure described in the Summary section should be made based on the description of the section, and the embodiment is only the specific example of the present disclosure described in the Summary section.

As described above, aspects of implementing the present disclosure has been described using the embodiment. However, an applicable embodiment of the present disclosure is not limited to the embodiment, and various modifications thereof could be made without departing from the scope of the present disclosure.

The present disclosure can be used in the manufacturing industry of hybrid vehicles.

What is claimed is:

1. A hybrid vehicle comprising:
an engine in which a filter for removing particulate matter is attached to an exhaust system;
a motor connected to an output shaft of the engine;
a power storage device that exchanges an electric power with the motor; and
a control device configured to set a target power of the engine based on a traveling power needed to travel, and control the engine and the motor to output the target power from the engine and travel based on the traveling power, wherein
the control device is configured to set the target power by imposing a limit when a deposition amount of the particulate matter deposited on the filter is equal to or greater than a predetermined amount, as compared to when the deposition amount is less than the predetermined amount.

2. The hybrid vehicle according to claim 1, wherein the control device sets the target power by imposing a strict limit when the deposition amount is larger as compared to when the deposition amount is smaller, when the deposition amount is equal to or greater than the predetermined amount.

3. The hybrid vehicle according to claim 1, wherein the control device sets an allowable upper limit power of the engine to be smaller when the deposition amount is equal to or greater than the predetermined amount as compared to when the deposition amount is less than the predetermined amount, and sets the target power within a range equal to or less than the allowable upper limit power based on the traveling power.

4. The hybrid vehicle according to any claim 3, wherein the control device sets an allowable upper limit engine speed of the engine to be small when the allowable upper limit power is smaller as compared to when the allowable upper limit power is larger, and controls the engine such that the engine speed of the engine is equal to or less than the allowable upper limit engine speed.

5. The hybrid vehicle according to claim 4, further comprising:
a planetary gear in which three rotational elements are connected to the engine, the motor, and a drive shaft coupled to an axle, such that the motor, the engine, and the drive shaft are arranged in this order in a collinear diagram; and
a second motor that is connected to the drive shaft and exchanges an electric power with the power storage device, wherein;
the control device sets an allowable upper limit vehicle speed based on the allowable upper limit engine speed, a range of an allowable rotation speed of the motor, and ranges of an allowable rotation speed of the rotational elements of the planetary gear, and controls the engine, the motor and the second motor such that the vehicle speed is equal to or less than an allowable upper limit vehicle speed.

6. The hybrid vehicle according to claim 4, further comprising:
a transmission of which an output shaft is connected to a drive shaft connected to an axle;
a planetary gear in which three rotational elements are connected to the engine, the motor, and an input shaft of the transmission such that the motor, the engine, and the input shaft are arranged in this order in a collinear diagram; and
a second motor that is connected to the drive shaft and exchanges an electric power with the power storage device, wherein;
the control device sets an allowable lower limit gear stage based on the allowable upper limit engine speed, a range of an allowable rotation speed of the motor, and a range of an allowable rotation speed of the planetary gear, and controls the transmission such that a gear stage is equal to or greater than the allowable lower limit gear stage.

7. The hybrid vehicle according to claim 1, wherein, when the control device sets the target power by imposing the limit, the control device notifies that output is insufficient when traveling by the traveling power is not possible and does not notify that output is insufficient when traveling by the traveling power is possible.

8. The hybrid vehicle according to claim 7, wherein, when the control device sets the target power by imposing the limit, the control device notifies that output is insufficient when a determination power based on the traveling power is larger than a threshold value and does not notify that output is insufficient when the determination power is equal to or less than the threshold value, and the threshold value is set to be a smaller value when a forced charging of the power storage device is requested as compared to when the forced charging of the power storage device is not requested.

9. The hybrid vehicle according to claim 8, wherein the threshold value is set to a sum of an allowable upper limit power of the engine and an allowable output electric power of the power storage device when the forced charging of the power storage device is not requested, and is set to the allowable upper limit power of the engine when the forced charging of the power storage device is requested.

10. The hybrid vehicle according to claim 8, wherein, when the control device sets the target power by imposing the limit, the control device sets the determination power by correcting the traveling power in consideration of at least one of air density of air taken into the engine, and difference between a charge/discharge request power of the power storage device and an actual charge/discharge request power.
